(19) United States
(12) Patent Application Publication
(10) Pub. No.: US 2026/0266677 A1
(43) Pub. Date: Sep. 10, 2026

(54) SYSTEM FOR MEASURING DIFFERENTIAL PRESSURE IN AN UNDERWATER ENVIRONMENT

(71) Applicants: PARIS SCIENCES ET LETTRES, Paris (FR); CENTRE NATIONAL DE LA RECHERCHE SCIENTIFIQUE (CNRS), Paris (FR); INSTITUT DE PHYSIQUE DU GLOBE DE PARIS, Paris (FR); UNIVERSITE PARIS CITE, Paris (FR)

(72) Inventors: Frédérick Boudin-Lenne, PARIS (FR); Pascal Bernard, PARIS (FR)

(73) Assignees: PARIS SCIENCES ET LETTRES, Paris (FR); CENTRE NATIONAL DE LA RECHERCHE SCIENTIFIQUE (CNRS), Paris (FR); INSTITUT DE PHYSIQUE DU GLOBE DE PARIS, Paris (FR); UNIVERSITE PARIS CITE, Paris (FR)

(21) Appl. No.: 19/491,275

(22) PCT Filed: Jun. 20, 2024
(86) PCT No.: PCT/EP2024/067266

§ 371 Date: Dec. 8, 2025

(30) Foreign Application Priority Data
Jun. 22, 2023 (FR) FR2306519

(51) Int. Cl. G01L 13/02

(52) U.S. Cl. CPC G01L 13/025

(57) ABSTRACT

A system includes a fiber measuring instrument. The fiber measuring instrument includes a first compartment in fluid connection with a first tube and filled with a first liquid. The fiber measuring instrument further includes a second compartment in fluid connection with a second tube and filled with a second liquid. The fiber measuring instrument further includes a valve that allows a fluid connection between the first tube and the second tube. The fiber measuring instrument further includes a membrane that separates the first compartment and the second compartment. The fiber measuring instrument further includes a window arranged in a shared wall between a third compartment and the first or second compartments. The fiber measuring instrument further includes a fiber optic head that forms a fiber interferometric sensor that measures a displacement of the membrane resulting from a pressure variation between the first compartment and the second compartment.

The present description relates to a system for measuring pressure in an underwater environment, and more specifically for measuring differential pressure, as well as to a method for measuring differential pressure in an underwater environment.

### PRIOR ART

Measurements of pressure variations are useful in numerous applications such as in medicine, petrochemistry or aerospace and aeronautics, for example, in wind tunnels.

In particular, pressure variation measurements are used in geosciences and seabed geodesy to measure variations in the sea level, in order, for example, to be able to detect height variations at several points of the earth's crust in order to study and anticipate seismic or volcanic events. These measurements also can be used for detecting tsunamis.

In order to carry out such pressure variation measurements, the use of resonant quartz crystal pressure sensors is known, i.e., sensors comprising quartz electric oscillators whose resonant frequency varies according to the pressure constraints they experience. Such resonant quartz crystal pressure sensors are described, for example, in the document in [Reference 1].

However, such sensors are complex sensors that need a source of electrical energy and an electronic component that must not experience oxidation. Beyond the cost they represent, these sensors therefore must be connected to an external power supply or even include a battery in the vicinity of the head of the sensor, i.e., where the interaction between the sensor and the environment to be measured occurs. This is not desirable when the sensors are deployed in harsh or remote environments where the intervention of humans, for example, to change a discharged battery, is extremely difficult or even impossible (deep drilling, seabed, irradiating or electromagnetic environment, high temperatures).

However, in the case of pressure measurements for applications in geosciences, it is often preferable to be as close as possible to certain areas of the earth's crust where major tectonic events occur. Thus, it is sometimes necessary for pressure measurements to be carried out at points on the earth's crust immersed at depths of several kilometers.

In this configuration, the use of quartz crystal pressure sensors therefore is not always adequate and other types of sensors would be preferred.

Other types of pressure sensors are known, such as a membrane interferometric pressure sensor, embodiments of which are disclosed, for example, in the document in [Reference 2]. A membrane interferometric sensor as described in the document in [Reference 2] comprises a Fabry-Pérot cavity closed by a membrane. An optical fiber projects a laser beam onto a first face of the membrane that reflects the signal toward the fiber. A second face of the membrane is in contact with an environment, outside the cavity, whose pressure is to be measured. A pressure variation in the environment results in a pressure variation on the second face of the membrane, which deforms, modifying how the laser beam is reflected toward the fiber. By analyzing the interference that occurs between the beam reflected by the membrane and a reference beam, for example, resulting from a reflection at the interface between the optical fiber and the cavity, it is possible to determine the pressure variations in the environment. In such a sensor, the generation of the laser signal and the pressure measurement by analyzing any interference can be carried out at a distance from the head of the sensor, by means of an optical fiber. The laser source, the associated power supply energy and the electronic components can be remotely located over significant distances. Good measurement sensitivity can be maintained provided that there is low dispersion and low absorption when the optical fiber conveys the optical beams.

However, the membrane interferometric sensor as described in the document in [Reference 2] is only adapted to micro-pressure measurements, i.e., measurements of pressure variations that are less than or equal to approximately ten kPa. Therefore, such a sensor is not adapted to measuring pressure in seabeds where the surrounding pressure can be greater than several hundred bar, i.e., greater than 10⁷ Pa.

An object of the present description is a system for measuring pressure applied to measurements of pressure variations under high pressure, notably in an underwater environment.

### SUMMARY OF THE INVENTION

In the present description, the term “comprise” means the same as “include” or “contain”, and is inclusive or open and does not exclude other elements that are not described or represented.

Furthermore, in the present description, the term “approximately” or “substantially” is synonymous with (means the same as) having a lower and/or upper margin of 10%, for example, 5%, of the respective value.

According to a first aspect, the present description relates to a system for measuring differential pressure in an underwater environment, comprising:
at least one first transceiver unit comprising a light source, detection means and signal processing means;
at least one first fiber measurement instrument configured to be positioned in a first position in said underwater environment and comprising:
   a first rigid compartment in sealed fluid connection with a first rigid tube, the first compartment being filled with a first liquid;
   a second at least partially rigid compartment in sealed fluid connection with a second at least partially flexible tube, the second compartment being filled with a second liquid;
   a third tube for underwater pressure tapping, said third tube opening into the underwater environment and being in fluid connection with the second tube;
   at least one first valve configured to allow, in the open position, a fluid connection between the first tube and the second tube, in order to maintain the first compartment and the second compartment at equal pressure, and configured to sealably separate, in the closed position, the first tube from the second tube;
   a membrane configured to separate the first compartment and the second compartment;
   a third sealed compartment filled with a fluid at atmospheric pressure;
   at least one first window, transparent within a given wavelength range, arranged in a shared wall between said third compartment and one of the first or second compartments;
   at least one first fiber optic head configured to form a first fiber interferometric sensor with said first transceiver unit, wherein said first fiber interferometric sensor is configured to measure, in the closed position of the first valve, through said first window, at least a first displacement of the membrane resulting from a pressure variation between the first compartment and the second compartment when the first measurement instrument experiences a variation in underwater pressure.

The term “rigid” in the present description is understood to mean that the first compartment and the first tube in fluid connection with the first compartment do not experience any deformations when they experience the pressures from the external environment relative to the pressure of the first liquid, for example, at most 5 bar.

In the present description, a second at least partially flexible tube is a tube that at least locally comprises flexible walls, i.e., walls that are characterized so as to be deformed when they experience the pressures of the external environment relative to the pressure of the second liquid, typically pressures of more than approximately 1 bar.

In the present description, a sealed separation produced by the membrane between the first compartment and the second compartment means that the membrane does not allow through any liquid below a predetermined threshold pressure, for example, a threshold pressure equal to approximately 1 bar, advantageously 5 bar.

In the present description, a sealed separation between the first tube and the second tube produced by the first valve in the closed position means that the first valve does not allow through any liquid below a predetermined threshold pressure, for example, a threshold pressure equal to approximately 10 bar, advantageously 200 bar.

The first fiber interferometric sensor is a contactless sensor configured to measure a displacement of the membrane as a function of an interferometric signal resulting from interference between a reference optical beam and a signal optical beam resulting from the membrane reflecting an incident optical beam emitted by said light source. Interferometric sensors known from the prior art can be implemented in a system for measuring differential pressure according to the first aspect. For example, an optical displacement sensor comprising a Fabry-Pérot type interferometer is known and is described, for example, in the document in [Reference 3].

According to one or more embodiments, said at least one first fiber optic head comprises:
a first optical fiber for conveying a light beam emitted by the light source toward the membrane, with an end of said first optical fiber being arranged in the third compartment;
a first collimator for collimating said light beam emitted by the source and originating from said first optical fiber, wherein said end of the first optical fiber is in an object focal plane of the collimator.

The reference optical beam is then, for example, an optical beam resulting from the end of said first optical fiber reflecting the incident optical beam emitted by said light source.

The system for measuring differential pressure according to the first aspect thus comprises at least said first fiber measurement instrument, which, during operation, is intended to be positioned in a first given position of the underwater environment whose pressure variations are to be measured and said first transceiver unit that can be remote from the measurement location, by virtue of fiber technology. The first transceiver unit comprises the light source, the means for detecting and processing the signal and can also comprise electrical power sources, as well as means for storing and/or transmitting the data.

The data thus can be processed at significant distances, up to a few tens of kilometers, thereby allowing underwater installations to be contemplated for measurement instruments at great depths.

Furthermore, in a system for measuring differential pressure according to the first aspect, the first and the second compartment remain at equal pressure when, in an initial state, the first measurement instrument is lowered in an underwater environment to the seabed and the first valve remains open. In order to initiate the differential pressure measurement, the first valve is closed. The first rigid compartment is isolated from the external pressure and retains the initial pressure. The second compartment, in fluid connection with an at least partially flexible tube, itself in connection with the underwater environment, experiences the external pressure variations and transmits the external pressure. A force is then created on the membrane producing a displacement proportional to the pressure variation. The applicants have found that the original arrangement of the first measurement instrument with two compartments separated by a first valve according to the first aspect allows differential pressure measurements in a high-pressure underwater environment, typically up to 5 bar, without any risk of damage to the membrane, since the membrane only experiences pressure variations and not the pressure of the underwater environment. It is thus possible for the instrument to safely descend to the deep seabed and to dispense with any high-pressure resistant protective structure, which is complex, expensive and which reduces the reliability of the instrument.

According to one or more embodiments, said first measurement instrument further comprises a mechanical protection enclosure not sealed from the underwater environment, with the first compartment, the second compartment and the third compartment being arranged inside said enclosure.

According to one or more embodiments, the fluid that fills the third compartment is a gas, for example, dry air or nitrogen.

According to one or more embodiments, the membrane comprises a thin film, for example, a silicon, stainless steel or titanium film, for example, in the form of a disk. A thickness of the thin film ranges, for example, between approximately 90 μm and approximately 500 μm.

Advantageously, the membrane can further comprise a thin reflective layer, for example, made of gold, in order to optimize the reflection of the incident beam. A thickness of the reflective layer ranges, for example, between approximately 2 μm and approximately 10 μm. The reflective layer is, for example, localized in a central region of the membrane.

According to one or more embodiments, the first liquid that fills the first compartment and/or the second liquid that fills the second compartment is transparent within a wavelength range ranging between approximately 1,300 nm and approximately 1,600 nm. This wavelength range corresponds to wavelengths of light beams advantageously used in a fiber interferometric sensor, for example, a sensor as described in the document in [Reference 3].

The term “transparent” is understood to mean that the liquid has absorption of less than approximately 20% throughout the considered wavelength range.

According to one or more embodiments, the first liquid that fills the first compartment and/or the second liquid that fills the second compartment has a density that is substantially equal to that of water, or is greater than that of water, advantageously greater than or substantially equal to twice that of water. The first liquid and/or the second liquid is preferably immiscible with water in order to limit any risks of leakage. A liquid denser than water is easier to manipulate.

In some embodiments, the first liquid that fills the first compartment and/or the second liquid that fills the second compartment has a coefficient of kinematic viscosity that is close to that of water, for example, ranging between approximately 1 and approximately 15 mm²/s in order to optimize the instrumental response. For the first liquid and/or the second liquid, perfluorinated oils can be used, for example, with a density that is equal to approximately 1.9, for example, the LYF oils by Lubrilog® (8 mm²/s at 20° C.) or silicone oils with a density approximately equal to 1, for example, silicone oils by MerckEurolab® or Lubrilog® (1 mm²/s at 20° C.).

In some embodiments, the first compartment comprises a wall made of a material whose coefficient of thermal expansion allows the thermal expansion of the first liquid located in the first compartment to be at least partially compensated. The larger the first compartment, the greater the sensitivity of the measurement, but the thermal sensitivity also increases. In some embodiments, the first liquid has a coefficient of thermal expansion ranging between approximately 10⁻⁵/° C. and approximately 1.1.10⁻³/° C., approximately 9.6.10⁻⁴/° C. and approximately 1.1.10⁻³/° C. In some embodiments, the wall of the first compartment can be made of a material with a high coefficient of thermal expansion, for example, ranging between 150.10⁻⁶/° C. and 230.10⁻⁶/° C., for example, between 200.10⁻⁶/° C. and 230.10⁻⁶/° C., for example, high-density polyethylene (HDPE) or low-density polyethylene (LDPE).

According to one or more embodiments, the first liquid and the second liquid are identical and the first compartment and the second compartment are thus filled with the same liquid.

In other embodiments, the first liquid and the second liquid are different. For example, the first liquid that fills the first compartment has an expansion coefficient that is lower than the expansion coefficient of the second liquid that fills the second compartment, with a ratio between the expansion coefficients ranging, for example, between approximately 1 and approximately 100, advantageously between approximately 10 and approximately 100. The applicant has shown that, with a difference between the expansion coefficients of the first liquid and of the second liquid, the impact of any temperature variations on the measurements could be reduced.

When choosing a different first liquid and second liquid, it is advantageously possible to choose immiscible liquids.

According to one or more embodiments, said first measurement instrument further comprises a fourth compartment in fluid communication with the first compartment, said fourth compartment comprising a wall and at least one first rigid element immersed in the first liquid flowing inside said fourth compartment, with said at least one first rigid element having a coefficient of thermal expansion that is lower than the coefficient of thermal expansion of the wall.

In particular cases where the thermal expansion of the material forming the wall of the first compartment does not allow the expansion of the first liquid to be compensated, such an arrangement allows the volume of the assembly made up of the first and fourth compartments to be increased, and allows the expansion of the first liquid to be compensated. Indeed, it is possible to generate a lower average thermal expansion of the rigid element/liquid assembly that can be compensated by the thermal expansion of the material forming the wall of the fourth compartment. For example, said at least one first rigid element has a coefficient of thermal expansion ranging between 10⁻⁶ m/m/° C. and 20×10⁻⁶ m/m/° C. For example, said at least one first rigid element is made of stainless steel, titanium, invar, or Pyrex. In some embodiments, said at least one first rigid element is a solid or hollow element. It is possible to have a first main rigid element and additional rigid elements that are smaller than the main rigid element in order to refine the compensation of the thermal expansion.

According to one or more embodiments, said first measurement instrument further comprises a second fiber optic head arranged in said third compartment and configured to form, with said transceiver unit, a second fiber interferometric sensor configured to measure a temperature variation in said third compartment. The variation in the temperature inside the third compartment will be very substantially identical to the temperature variation inside the first liquid and/or the second liquid. By measuring possible temperature variations, any measurement artifacts related to the thermal expansion, notably of the first liquid, can be compensated.

According to one or more embodiments, said first measurement instrument further comprises:
a fourth sealed compartment filled with a fluid at atmospheric pressure, for example, air;
a second window arranged in a shared wall between said fourth compartment and the other one from among the first or second compartments; and
a third fiber optic head configured to form a third fiber interferometric sensor with said first transceiver unit, wherein said third fiber interferometric sensor is configured to measure, in the closed position of the first valve, through said second window, a second displacement of the membrane resulting from a pressure variation between the first compartment and the second compartment when the system experiences a variation in underwater pressure.

A double measurement will allow a possible drift in the first fiber interferometric sensor to be determined, with said drift resulting, for example, from a drift in the wavelength of the light source, and will allow the resulting measurement artifacts to be corrected.

According to one or more embodiments, said first measurement instrument further comprises a fourth fiber optic head arranged in said third compartment and configured to form, with said first transceiver unit, a fourth fiber interferometric sensor configured to measure a drift in said first fiber optic displacement sensor.

Such a fiber interferometric sensor can allow a drift in the first sensor to be detected and the resulting measurement artifacts to be corrected, while dispensing with a fourth compartment with a second window.

According to one or more embodiments, the system for measuring differential pressure in an underwater environment according to the first aspect further comprises a second differential pressure measurement instrument configured to be positioned in a second position in said underwater environment. With differential pressure measurements carried out at different positions, it will be possible to interpret the source of these underwater pressure variations with greater reliability.

In some preferred embodiments, said second measurement instrument is a fiber measurement instrument that cooperates with said first transceiver unit for measuring the differential pressure. For example, the second measurement instrument is a measurement instrument with features similar to those of the first measurement instrument. It is then possible to work with the same source for the two measurement instruments. This allows any possible internal drift of the two instruments to be corrected, by determining the difference in the measurements provided by the two instruments, with this drift being identical for the two instruments because they operate with the same light source. It is then possible to analyze, for example, a variation in altitude or a relative vertical displacement between the two instruments, for example, when one of them is located on the circumference of an underwater volcanic structure and the other on a peak area. It is then possible to analyze a variation in the sea level between the two instruments, for example, a difference in the sea level produced by a tsunami.

According to a second aspect, the present description relates to a method for measuring differential pressure in an underwater environment implemented by means of a system for measuring differential pressure according to the first aspect.

According to one or more embodiments, the method comprises:
opening the first valve for establishing an equal pressure between the first compartment and the second compartment;
installing said first measurement instrument in the underwater environment where a differential pressure is intended to be measured;
closing the first valve so as to sealably separate the first tube from the second tube;
measuring, in the closed position of the first valve, through said window, a displacement of the membrane resulting from a pressure variation between the first compartment and the second compartment when the first measurement instrument experiences a variation in underwater pressure.

### BRIEF DESCRIPTION OF THE FIGURES

Further advantages and features of the invention will become apparent upon reading the description, which is illustrated by the following figures:

FIG. 1 shows a diagram of an example of a system for measuring differential pressure in an underwater environment according to the present description;

FIG. 2 shows a diagram illustrating the displacement of the membrane in a system for measuring differential pressure according to the present description, when the system is in use;

FIG. 3A shows a diagram of a membrane, in a first embodiment;

FIG. 3B shows a diagram of a membrane, in a second embodiment;

FIG. 4 shows a photo showing an example of a membrane in accordance with the membrane illustrated in FIG. 3B;

FIG. 5A shows a diagram of a membrane in a third embodiment, in use in an example of a system for measuring differential pressure according to the present description, in an initial state;

FIG. 5B shows a diagram of the membrane described in FIG. 5A, in use in an example of a system for measuring differential pressure according to the present description, during a differential pressure measurement;

FIG. 6 shows a diagram of another example of a system for measuring differential pressure in an underwater environment according to the present description;

FIG. 7 shows a diagram of an example of another example of a system for measuring differential pressure in an underwater environment according to the present description;

FIG. 8 shows a diagram of another example of a system for measuring differential pressure in an underwater environment according to the present description;

FIG. 9A shows a diagram of a collimator in an example of a first optical fiber head of a measurement apparatus according to the present description, with the collimator being configured to spatially form a light beam originating from an optical fiber of said first optical fiber and its orientation toward the membrane;

FIG. 9B shows a diagram illustrating the operation of the collimator shown in FIG. 9A in greater detail, when said collimator has an alignment error.

The appended figures are schematic and are not necessarily to scale, above all they are intended to illustrate the principles of the invention. In the figures, identical elements (or parts of elements) are identified using the same reference signs when possible.

### DETAILED DESCRIPTION OF THE INVENTION

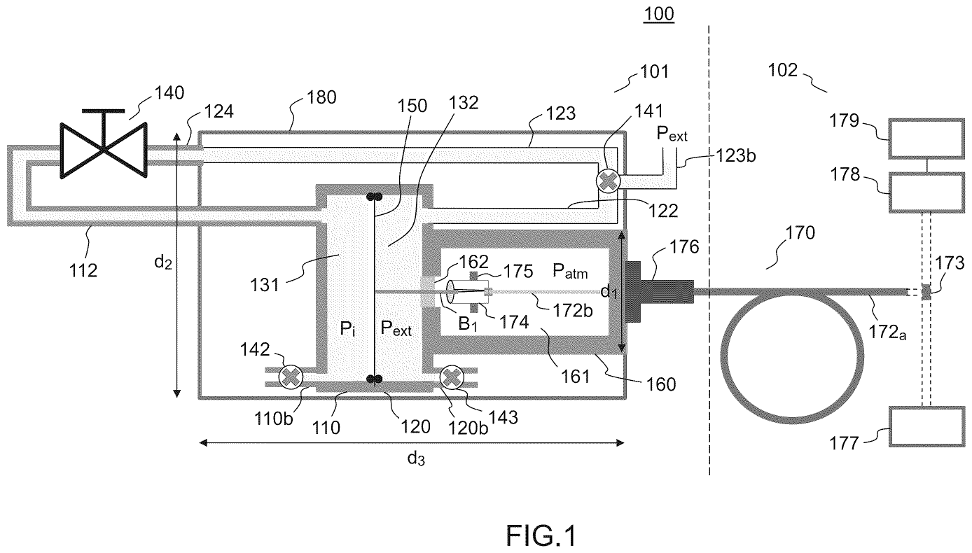

FIG. 1 shows a diagram of an example of a system 100 for measuring differential pressure in an underwater environment according to the present description. The system 100 comprises at least a first measurement instrument 101 and an optical transceiver unit 102.

The measurement instrument 101 comprises a first rigid compartment 110 in sealed fluid connection with a first rigid tube 112 and a second at least partially rigid compartment 120 in sealed fluid connection with a second at least partially flexible tube 122. The first compartment is filled with a first liquid 131 and the second compartment is filled with a second liquid 132. In some embodiments, the first compartment and the second compartment are filled with the same liquid, with the first liquid and the second liquid being identical. The second tube 122 is in fluid connection with a third tube 123b that is open to the underwater environment for underwater pressure tapping. The second tube 122 is partially flexible to facilitate the transmission of the external pressure during operation. For example, as illustrated in FIG. 1, the second tube 122 is directly connected to the third tube 123b by means of a second valve 141, for example, a T-shaped 3-way valve allowing liquidation and through which the external pressure Pₑₓₜ is transmitted.

The measurement instrument 101 further comprises a first valve 140 configured to allow, in the open position, a fluid connection between the first tube 112 and the second tube 122. The first valve 140 thus allows, in the open position, the first compartment 110 and the second compartment 120 to be maintained at equal pressure. The first valve 140 is also configured, in the closed position, to sealably separate the first tube 112 from the second tube 122. The first valve 140 therefore allows the compartment 110 to be isolated and an initial pressure Pᵢ to be maintained inside the first compartment 110. The differential pressure is then quantified relative to this initial pressure.

As illustrated in FIG. 1, the measurement instrument 101 also comprises a membrane 150 configured to separate the first compartment and the second compartment.

The measurement instrument 101 further comprises a third sealed compartment 160 filled with a fluid 161 at atmospheric pressure Pₐₜₘ, for example, a gas, for example, dry air or nitrogen, and a window 162, transparent within a given wavelength range, arranged in the example shown in FIG. 1 in a shared wall between the third compartment 160 and the second compartment 120.

In some embodiments, at least the second compartment 120 and the third compartment 160 comprise walls with a coefficient of thermal expansion of less than 20×10⁻⁶ m/m/° C., for example, stainless steel or titanium walls.

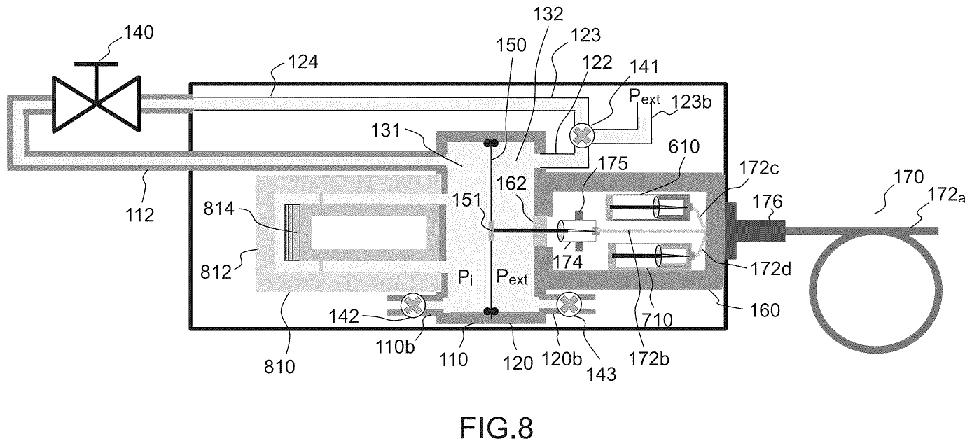

In some embodiments, the first compartment 110 comprises a wall made of high-density polyethylene or of another material with a linear coefficient of thermal expansion greater than approximately 200 μm/m/° C., thereby at least partially compensating for the expansion of the first liquid in the first compartment and thus minimizing the thermal sensitivity of the instrument. As will be described in further detail with reference to FIG. 8, the first compartment also can be in fluid communication with a fourth compartment, inside which a rigid element (for example, made of stainless steel, titanium, invar or Pyrex) is immersed in the first liquid that expands less than the first liquid. It is then possible to adjust the equivalent expansion of the liquid plus rigid element assembly with the temperature and thus optimize the thermal compensation.

As illustrated in FIG. 1, the first compartment 110, the second compartment 120 and the third compartment 160 can be arranged in a mechanical protection enclosure 180 that is not sealed from the outside.

The enclosure 180 provides mechanical protection for the various compartments (against impacts, manipulation, etc.) but must not be sealed from the surrounding environment so as not to impede the measurement of the differential pressure. It is, for example, similar to a cylinder with a length, for example, that is less than or equal to 1 m and an outer diameter, for example, that is greater than 10 cm, for example, ranging between approximately 10 cm and approximately 20 cm.

The first valve 140 is placed, for example, outside this enclosure so that it can be manipulated, by a remotely operated underwater vehicle (or “ROV”). The first valve 140 also can be located inside the protective enclosure 180 if a solenoid valve is selected. The first valve 140 is advantageously sealed against pressure variations of more than several tens of bar, throughout the operation duration of the instrument, which can be more than several years. The first valve is, for example, made of stainless steel or titanium.

In order to ensure that there is equal pressure between the first compartment and the second compartment (first open valve), the second at least partially rigid compartment 120 is in sealed fluid connection with the second at least partially flexible tube 122.

The material forming the flexible tube 122 can be selected so as to be compatible with the external environment and with the second liquid 132, i.e., non-porous and not chemically reactive. For example, a material of the polyvinyl chloride (PVC) type can be selected for the material forming the flexible tube. In the example shown in FIG. 1, the flexible tube 123 is located inside the protective enclosure 180. Outside the enclosure, the flexible tube 123 of the second tube 122 can be extended by a section 124 made of material that is more robust and more rigid in order to withstand external impacts, for example, stainless steel or titanium. The section 124 extends to the first valve 140 separating the first tube 112 and the second tube 122.

The first rigid compartment 110 is, for its part, in sealed fluid connection with a first rigid tube 112. The first rigid tube 112 comprises, for example, a tube, as illustrated in FIG. 1. It is rigid enough to not experience any deformations when it experiences the pressures from the external environment relative to the pressure of the first liquid 131. The aim is to ensure that the first liquid 131 inside the first compartment 110 does not experience any compression despite the pressure variations of the surrounding external environment. In other words, the intention is to ensure that the volume of the first compartment remains at an initial reference pressure before closing the first valve 140, which isolates the first compartment 110 from the second compartment 120. For example, the first tube 112 is made of stainless steel or of titanium.

The second liquid 132 that fills the second compartment 120, the second at least partially flexible tube 122 and the third tube 123b is preferably non-absorbent in the near-infrared domain, more specifically, it is preferably transparent in a wavelength range ranging between approximately 1,300 nm and approximately 1,600 nm. Indeed, light beams at such wavelengths notably can be conveyed in very long optical fibers with very low attenuation. For example, wavelengths that are currently used in telecommunications can be used, namely, 1,310 nm and 1,550 nm.

For the second liquid 132, water can be used, but since water is absorbent in the near-infrared domain, this reduces the distance that the incident optical beam can cover in the liquid, and consequently reduces the measurement range for the differential pressure. Thus, in practice, a liquid immiscible with water and denser than water will instead be selected so as to minimize the risk of leakage. Thus, an oil can be selected, for example, an oil that is at least two times denser than water. For example, a perfluorinated oil can be used.

The first liquid 131 can be identical to the second liquid 132. However, different liquids, preferably immiscible liquids, can be selected. For example, the first liquid 131 that fills the first compartment can have an expansion coefficient that is lower than the expansion coefficient of the second liquid 132 that fills the second compartment, with the difference between the expansion coefficients ranging, for example, between approximately 1 and approximately 100, for example, between approximately 10 and approximately 100. The applicant has shown that, with a difference between the expansion coefficients of the first liquid and of the second liquid, the impact of the temperature variations on the measurements could be reduced.

For example, pure water can be used for the first liquid 131, and an oil can be used for the second liquid.

In some embodiments, the first measurement instrument further comprises a valve 142 arranged on a tube 110b in fluid communication with the first compartment 110 and/or a valve 143 arranged on a tube 120b in fluid communication with the second compartment 120. These valves allow the liquid to be injected into the instrument and/or allow drainage. This also allows the liquid to be isolated from the outside when transporting the instrument, for example, before launching it into water.

The first measurement instrument 101 also comprises a fiber optic head 170 configured to form, with the transceiver unit, a fiber interferometric sensor. This fiber interferometric sensor is configured to measure, in the closed position of the first valve, through the window 162, a displacement of the membrane resulting from a pressure variation between the first compartment 110 and the second compartment 120 when the first measurement instrument experiences a variation in underwater pressure. The window 162 allows the incident light beam, for example, a laser beam with a diameter ranging between approximately 0.5 mm and approximately 3 mm to pass from the third compartment (160, FIG. 1) at atmospheric pressure to one of the first and second compartments separated by the membrane.

In the example shown in FIG. 1, the window 162 is arranged in a shared wall between the third compartment 160 and the second compartment 120 connected to the at least partially flexible tube and that transmits the pressure variations of the external environment when the first valve 140 is closed. However, in other configurations, the window actually can be arranged in a shared wall between the third compartment 160 and the first rigid compartment 110 configured to remain at the same reference pressure Pᵢ when the first valve 140 is closed. The window 162 has suitable optical and mechanical properties. It is made of a material that can withstand the external pressure of the seabed, and notably of the deep seabed, for example, up to approximately 600 bar. For example, silica, or advantageously sapphire, can be used for the window, which have very good mechanical properties for withstanding high pressures. The window 162 is also designed to allow through the incident laser beam and the reflected laser beam with the least possible absorption and maximum transmission. In order to minimize any parasitic reflections, the window can be coated with an anti-reflective treatment, advantageously on each face thereof.

In some embodiments, the window assumes the shape of a sheet with flat and parallel faces. It is, for example, cylindrical, and has, for example, a diameter ranging between approximately 2 cm and approximately 5 cm and, for example, a thickness ranging between approximately 5 mm and approximately 15 mm in order to optimize resistance to external high pressures.

In some embodiments, the first measurement instrument has dimensions d₁, d₂, d₃, with d₁ ranging between approximately 5 cm and approximately 15 cm, d₂ ranging between approximately 10 cm and approximately 20 cm, d₃ ranging between approximately 50 cm and approximately 1 m.

As illustrated in FIG. 1, the fiber optic head 170 generally comprises an optical fiber 172a, 172b configured to convey an incident light beam B₁ in the third compartment 160 that is emitted by a light source 177 of the transceiver unit, remote from the environment where the measurement is carried out. As will be described in further detail hereafter, the incident light beam is directed toward the membrane 150 and is reflected by said membrane. The reflected beam interferes with a reference beam in order to form an interferometric signal sent to detection means 178 of the transceiver unit. The signal thus detected is processed by signal processing means 179 of the transceiver unit in order to determine a displacement of the membrane 150. During operation, a displacement of the membrane results in a modification to the optical path followed by the reflected beam and consequently a modification to the interference signal. In some embodiments, a prior calibration of the system allows a pressure variation to be associated with a displacement of the membrane.

In a system 100 for measuring differential pressure as illustrated in FIG. 1, it is thus possible to distinguish the measurement instrument 101 from all the elements intended to be positioned in the environment where the measurement is carried out and the transceiver unit 102 from all the elements remote from said environment, arranged, for example, on a surface platform (port or marine platform). The transceiver unit 102 comprises, for example, all the electrical, electronic, or power supply elements and, in general, all the elements that are difficult to maintain or operate in an underwater environment. The transceiver unit 101 and the measurement instrument 102 are connected by the optical fiber 172a, 172b.

In the example shown in FIG. 1, the optical fiber comprises a first section 172a for conveying light between the surface platform and the third compartment. This first section comprises a reinforced sheath, for example. It can be from a few tens of meters to a few tens of kilometers long, for example, between approximately 10 m and approximately 40 kms long.

The optical fiber also comprises, in the example shown in FIG. 1, a second section 172b for conveying light in the third compartment 160. The measurement instrument can comprise a sealed connection element 176 allowing the optical fiber to be inserted into the third compartment 160.

As illustrated in FIG. 1, the fiber optic head advantageously comprises a collimator 174 at the outlet of the fiber section 172b configured to form a collimated incident beam from the light beam originating from the fiber 172b and a plate 175 for optically aligning the collimator 174 in order to optimize the reflection of the collimated beam on the membrane 150. The collimator 174 and the plate 175 are arranged inside the third compartment 160. The collimator 174, by collimating the optical beam, advantageously allows the membrane 150 to be focused at a distance ranging between 5 mm and 20 mm from the collimator. This distance of several centimeters firstly allows the beam to exit the optical fiber in the air. This allows a fiber/air interface to be provided that allows a reference beam to be generated resulting from the reflection (approximately 4%) on said interface. Furthermore, the collimated beam passes through the second liquid 132 of the second compartment 120 over a distance that is large enough to not experience any artifacts that could result from an excessively thin layer of liquid. The centimetric distance of the membrane relative to the fiber outlet also affords more flexibility in terms of the choice of the membrane (dimension, thickness) in order to optimize the sensitivity and the measurement range of the instrument.

During operation, in a system for measuring differential pressure as illustrated in FIG. 1, while descending to the seabed, the first valve 140 is open, the first compartment 120 at the pressure Pₑₓₜ and the second compartment 110 at the pressure Pᵢ are at equal pressure with one another (Pₑₓₜ=Pᵢ), but also at equal pressure with the external environment, then, once it has been placed on the seabed, for the differential pressure measurement, the first valve is closed and retains an initial state of the pressure in the isolated compartment 110.

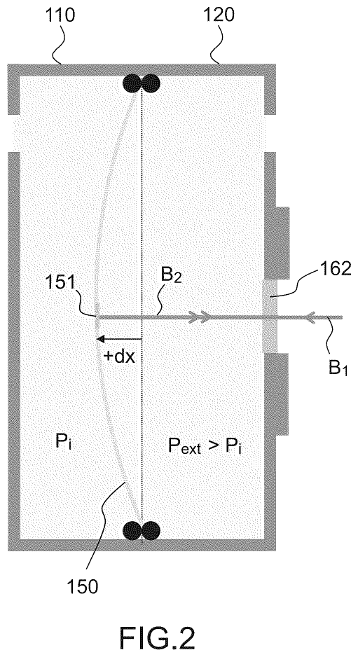

FIG. 2 thus illustrates the deformation of the membrane, when the first valve is closed and a pressure variation is exerted by the underwater environment relative to the initial state.

In FIG. 2, for the sake of simplification, only the first compartment 110, the second compartment 120 and the window 162 of the third compartment are shown.

The first rigid compartment 110 remains isolated from the external pressure and retains the initial pressure P₁. The second compartment, in fluid connection with an at least partially flexible tube, for its part experiences the external pressure variations. The pressure of the second compartment differs. A force is then created on the membrane producing a displacement proportional to the pressure variation. Thus, a pressure Pₑₓₜ of the second compartment that is greater than the pressure Pᵢ of the first compartment causes a displacement +dx of the membrane and, conversely, a lower pressure Pₑₓₜ will result in a displacement −dx.

A prior calibration of the system could allow the differential pressure to be determined based on the displacement value dx.

Fiber interferometric sensors for measuring the displacement dx are known from the prior art and can be implemented in a system for measuring differential pressure according to the present description.

For example, an interferometric sensor comprising a Fabry-Pérot type interferometer is known and is described, for example, in the document in [Reference 3].

As illustrated in FIG. 2, an incident optical beam B₁ originating from the optical fiber 172b passes through the window 162 and is reflected onto the membrane 150, which is moving due to pressure variations. The reflected beam B₂ is again conveyed by the fiber. Interference occurs between the beam reflected by the membrane B₂ and a beam reflected at the tip of the fiber, not shown in the figure. When the membrane moves, the reflected beam experiences a variation in the optical path and a modification to the interference pattern then occurs. The variations in the interference pattern are recorded by the detection means (178, FIG. 1) and then the processing unit 179 allows the differential pressure measurement to be deduced therefrom. As described above, a collimator 174, advantageously arranged on an adjustment plate, allows the incident optical beam to be collimated.

The centimetric distance between the tip of the fiber 172b and the membrane enabled by the collimator configured to produce a collimated incident beam also enable a large measurement range to be provided and thus allow significant displacements dx of several hundred um and therefore allow pressure variations close to 5 bar to be measured, while retaining sufficient sensitivity in order to provide high resolution of the sea level close to 0.1 mm, that is, ^{~}1 Pa. The membrane 150 is configured to sealably separate the first compartment and the second compartment, i.e., it does not allow any liquid to pass below a predetermined threshold pressure, for example, a threshold pressure equal to approximately 5 bar, advantageously 10 bar.

The parameters of the membrane (material, thickness, dimensions) depend on the desired capacities, and notably on the sensitivity, i.e., the capacity to deform as a function of the pressure variation, the desired differential pressure measurement range, the desired mechanical resistance threshold.

The material for the membrane is selected so as to be compatible with the one or more liquids used and with the materials of the first compartment and of the second compartment, in order to avoid any oxidation-reduction phenomena that can occur even when isolating seals are present between the membrane and the two compartments.

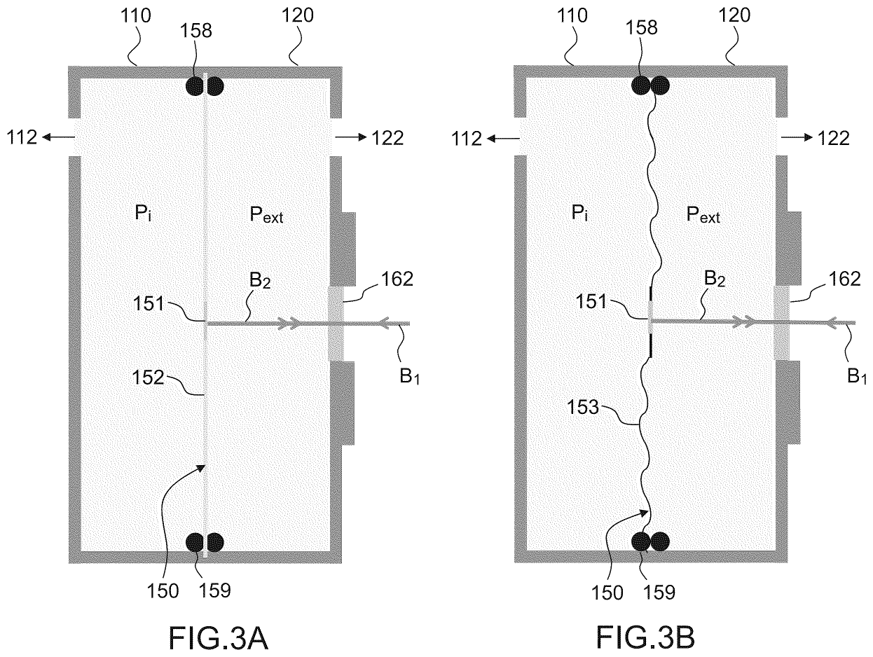

FIG. 3A and FIG. 3B thus illustrate two first examples of membranes arranged in a system for measuring differential pressure according to the present description, for separating the first compartment and the second compartment. As for FIG. 2, only the first compartment 110, the second compartment 120 and the window 162 of the third compartment are shown.

FIG. 3A illustrates a first example of a membrane 150 according to the present description. In this example, the membrane comprises a thin film 152, for example, a silicon film, for example, in the form of a disk. Other materials can be used, for example, stainless steel or titanium. The thickness ranges, for example, between approximately 90 μm and approximately 500 μm.

In the case whereby the membrane assumes the form of a disk, the diameter can range, for example, between 50 mm and approximately 100 mm. Generally, the sensitivity of the membrane depends, in a known manner, on the mechanical properties of the material used, on the thickness of the membrane and on the maximum dimensions of the membrane, for example, a diameter in the case whereby the membrane assumes the form of a disk.

Advantageously, the membrane 150 can comprise a thin reflective layer 151 for optimizing the reflection quality of the laser beam on its surface and for increasing the optical sensitivity of the instrument. The reflective layer can be located in the region of the membrane where the impact occurs with the incident light beam, for example, in a central region. The reflective layer is, for example, a gold layer, with a thickness, for example, ranging between approximately 2 μm and approximately 10 μm. The reflective layer is at least located on the side of the membrane that receives the incident light beam.

As illustrated in FIG. 3A, the membrane 150 is arranged so as to sealably separate the first compartment and the second compartment. The seal is provided, for example, by means of seals 158, 159. In some embodiments, the first compartment 110 and the second compartment 120 form a cylinder and the membrane separates the cylinder into two parts in order to form each of the compartments. Each compartment has, for example, an internal dimension, measured toward the incident ray, ranging between approximately 3 mm and approximately 5 mm. The volume of each compartment ranges, for example, between approximately 10 cm and approximately 100 cm³.

FIG. 3B illustrates a second example of a membrane 150 according to the present description.

In this example, the membrane comprises a thin film 153 (with a thickness ranging, for example, between approximately 90 μm and approximately 100 μm) with a concentric accordion shape allowing the linearity range of the instrument to be increased. As previously, the membrane 150 illustrated in FIG. 3B can comprise a thin reflective layer 151 for optimizing the reflection quality of the laser beam on its surface and for increasing the optical sensitivity of the instrument.

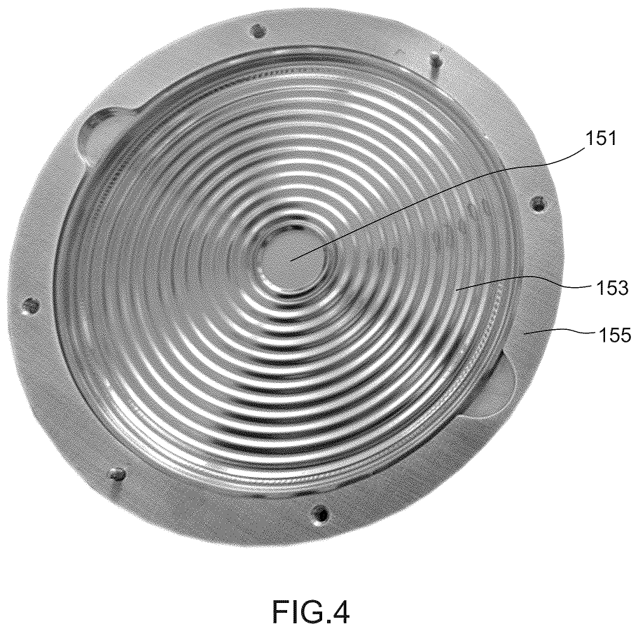

FIG. 4 shows, by way of an illustration, a photograph of an example of such a membrane made of copper beryllium (CuBe) arranged in a support 155.

For such an accordion-shaped membrane, each corrugation can deform independently and generate a displacement of the center of the membrane. The sum of these displacements allows a measurement to be carried out in a greater linear domain than for a smooth membrane as shown in FIG. 3A, which can only deform in a single plane.

As in the example shown in FIG. 3A, the seal is provided, for example, by means of seals 158, 159. As in the example shown in FIG. 3A, the first compartment 110 and the second compartment 120 can form a cylinder and the membrane separates the cylinder into two parts, for example, two similar parts, in order to form each of the compartments.

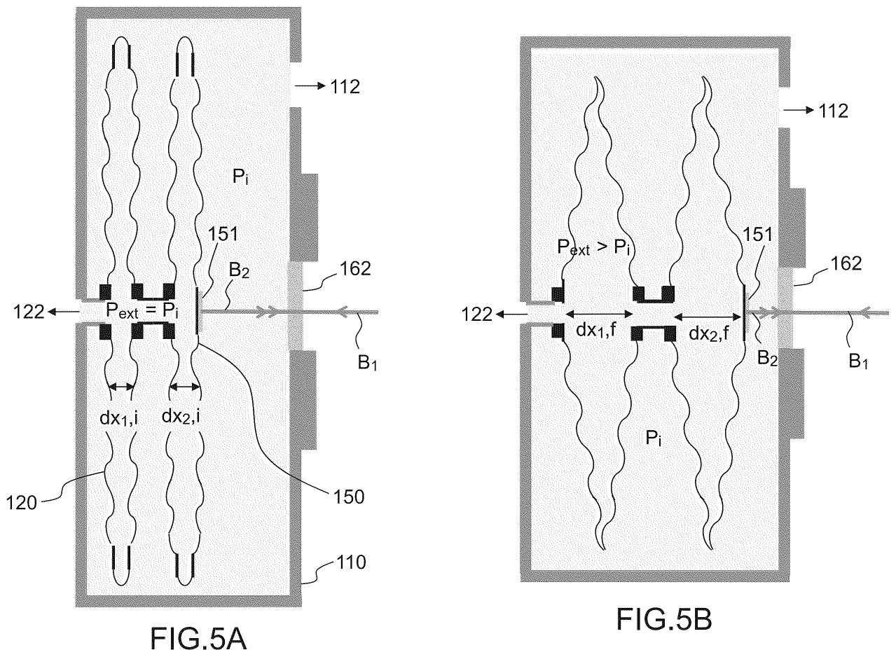

FIG. 5A and FIG. 5B illustrate a third example of a membrane 150 according to the present description arranged in a system for measuring differential pressure according to the present description.

In this example, several membranes are associated with each other in order to form one or more bellows filled with the first liquid 131. The one or more bellows form the second at least partially flexible compartment 120 in fluid communication with the second tube 122. As illustrated in FIG. 5A and FIG. 5B, the window 162 in this example is arranged in a shared wall with the first rigid compartment 110 and the third compartment 160 (not shown).

During operation, the incident beam B₁, as previously, can be reflected by a central reflective region 151.

FIG. 5A illustrates an initial state when the pressure in the compartment 120 is equal to the initial pressure Pᵢ. FIG. 5B illustrates a measurement state when the pressure Pₑₓₜ in the compartment 120 is, for example, greater than the initial pressure Pᵢ. An increase in the pressure Pₑₓₜ is transmitted by virtue of the second tube 122 in fluid communication with the third tube (not shown in FIG. 5A and FIG. 5B) open to the underwater environment and causes the one or more bellows to widen, which in turn causes the membrane to displace.

As illustrated by way of an example in FIG. 5B, the displacement of the membrane 150 in this example results in the widening of the two bellows. This results in a displacement equal to dx_{1,f}−dx_{1,i}+dx_{2,f}−dx_{2,i}, where dx_{1,i}, dx_{2,i} are the thicknesses of the bellows measured toward the incident beam, in the initial state, and dx_{1,f}, dx_{2,f} are the thicknesses of the bellows in the measurement state.

The measurement sensitivity thus can be increased with the number of bellows.

In advantageous embodiments, other measurements can be provided for measuring and at least partially compensating for any drifts in the sensor and/or for measuring and at least partially compensating for the effects of any temperature variations within the measurement system 100.

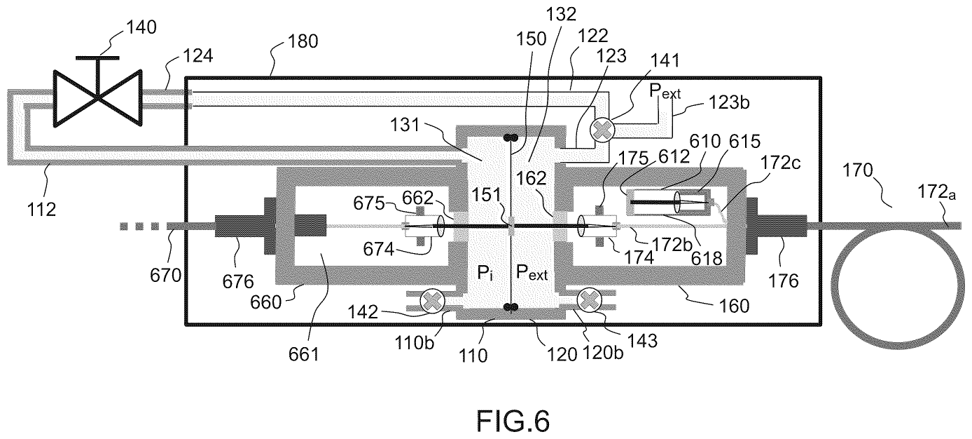

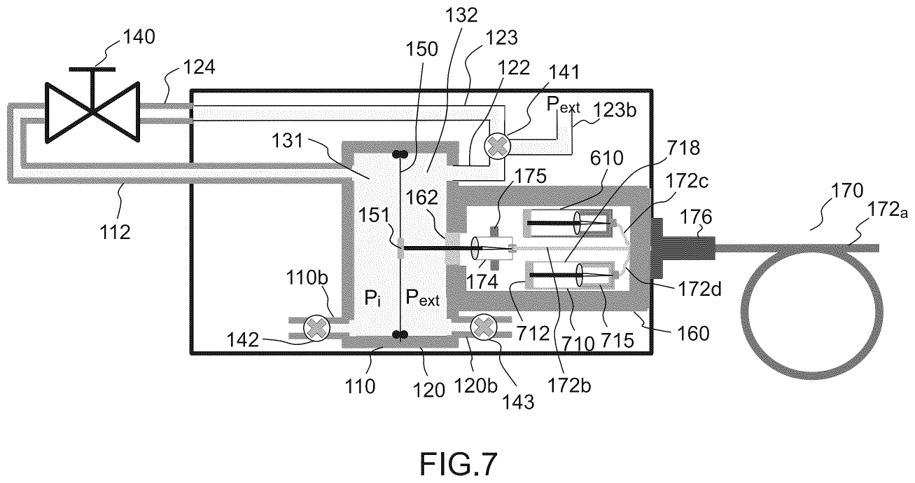

FIG. 6, FIG. 7 and FIG. 8 thus illustrate various embodiments of systems for measuring differential pressure in an underwater environment according to the present description. For the sake of simplification, only the measurement instrument is shown in these figures.

FIG. 6 thus shows a diagram of an example of a system for measuring differential pressure in an underwater environment according to the present description, comprising, inside the third compartment 160, a second fiber optic head 610 configured to form, with the transceiver unit, a second fiber interferometric sensor configured to measure a temperature variation inside the third compartment.

In this example, the second fiber optic head 610 comprises a tube 618 configured to expand with the temperature. A reflective target 612, for example, a gold pad, is located at the end of the tube. A light beam emitted by the same source as that of the first sensor and originating from an optical fiber 172c allows the target 612 to be illuminated. As for the first optical head 170, a collimator 615 can be used to collimate the beam exiting the fiber. A measurement of the displacement of the target 612 resulting from the variation in the length of the tube is carried out in the same way as for the measurement of the displacement of the membrane by means of the first sensor. It is then possible to deduce a temperature variation in the third compartment 160 that represents the temperature of the instrument 101. This measurement of temperature variation allows any measurement artifacts to be corrected, for example, by means of a prior calibration of the system. The calibration comprises, for example, an estimation of a displacement of the membrane as a function of a temperature variation.

Furthermore, the measurement instrument illustrated in FIG. 6 further comprises a fourth sealed compartment 660, filled with a fluid 661 at atmospheric pressure, for example, a gas, for example, air or nitrogen, a second window 662 arranged in a shared wall between said fourth compartment 660 and one of the first or second compartments 110, 120. The measurement instrument further comprises a third fiber optic head 670 configured to form, with the transceiver unit (not shown in FIG. 6), a third fiber interferometric sensor configured to measure a second displacement of the membrane, in the closed position of the first valve, through the second window. In this example, the first window 162 is arranged in a shared wall between the third compartment 160 and the second at least partially flexible compartment 120 and the second window 662 is arranged in a shared wall between the fourth compartment 660 and the first rigid compartment 110, but the opposite is also possible. This particular arrangement allows two measurements to be carried out on either side of the membrane 150 and thus allows any internal drifts in the sensor to be controlled that are associated, for example, with aging of the laser source and with a variation in the associated wavelength, which can introduce an artifact on the measurement of the displacement of the membrane and therefore of the differential pressure.

In this embodiment, reflective central gold layers can be located on either side of the membrane.

A light beam originating from the same laser source as that of the first sensor is transmitted by means of an optical fiber to the second window 662, for example, by means of a sealed connection element 676 allowing the optical fiber to be inserted into the fourth compartment 660. As in the example of the first fiber optic head 170, the fiber optic head 670 advantageously comprises a collimator 674 at the outlet of the fiber configured to form a collimated incident beam and a plate 675 for optically aligning the collimator 674 in order to optimize the reflection of the collimated beam on the membrane 150. The collimator 674 and the plate 675 are arranged inside the fourth compartment 660.

The third fiber optic displacement sensor operates in the same way as the first sensor and therefore measures a displacement that should have the same amplitude but be in the opposite direction to that measured by the first sensor. In the event of drift in the source, the sum of the measured displacements is not zero and the correction to be applied can be deduced.

Of course, the second fiber optic displacement sensor illustrated in FIG. 6 for measuring the temperature and the fourth compartment 660 equipped with the second window 662 for compensating for any drifts can be provided in the system for measuring differential pressure independently of each other.

FIG. 7 shows a diagram of another example of a system for measuring differential pressure in an underwater environment according to the present description.

The system comprises, for example, a fiber optic head 610 configured to form a temperature sensor as described above.

In this embodiment, the system further comprises, inside the third compartment 160, a fourth fiber optic head 710 configured to form, with the transceiver unit, a fourth fiber optic displacement sensor (reference sensor) configured to measure a drift of the first fiber optic displacement sensor. It is thus possible to control any internal drifts of the first sensor, due, for example, to aging of the source and to a variation in the associated wavelength.

Compared with the system described in FIG. 6, the fourth sensor avoids an embodiment with two windows and using two sealed passages 176 and 676 that is bulkier and reduces reliability.

In this example, the fiber optic head 710 comprises a tube 718 made of a material that does not expand with the temperature, for example, a glass of the glass-ceramic type, such as Zerodur®. A reflective target 712 is located at the end of the tube, for example, a gold mirror. A light beam originating from the same source as that of the first sensor originating from an optical fiber 172d allows the target 712 to be illuminated. A measurement indicating displacement of the target 712 necessarily results from drift of the source since the tube does not expand. A difference between the signal of the displacement acquired with the first sensor and the signal acquired with the reference sensor allows a corrected signal to be acquired.

FIG. 8 shows a diagram of another example of a system for measuring differential pressure in an underwater environment according to the present description.

The measurement instrument in this example (optionally) comprises a temperature sensor 610 as described above and a sensor 710 for measuring the drift of the source, as described above.

The measurement instrument further comprises a fourth compartment 810 in fluid communication with the first compartment 110, with said fourth compartment comprising a wall 812 and, according to some examples, at least one first rigid element 814 immersed in the first liquid 131 flowing inside the fourth compartment, with said at least one first rigid element having a coefficient of thermal expansion lower than the coefficient of thermal expansion of the wall. Such an arrangement allows any expansion of the liquid in the first compartment 110 to be compensated.

Indeed, in the first compartment 110, if the liquid expands at constant pressure, it increases in volume and therefore causes a displacement of the membrane, expressing a negative pressure variation measurement error. This expansion of the liquid 131 can be compensated or minimized by virtue of the additional compartment 810 in fluid communication with the first compartment 110. An ideal case would be a compartment with a variation in volume after expansion that is identical to that of the first liquid. In this case, the membrane 150 will not experience any displacement error.

However, it is difficult to find a material for the compartment where the expansion coefficient is perfectly adapted to compensate for the expansion of the first liquid.

It is then possible to add, inside the compartment 810, at least one first rigid element 814 with a lower expansion coefficient than that of the first liquid, such as stainless steel or titanium, advantageously with a very low expansion coefficient, such as invar, Zerodur, or silica. The liquid and rigid solid association allows the equivalent expansion of the assembly to be reduced, and even allows it to be precisely adjusted to that of the first compartment by computing, then by installing a precise proportion of the rigid volume. This adjustment can be implemented by installing small additional rigid elements, for example, disks with a certain diameter and with a certain thickness.

It should be noted that in the examples of the systems illustrated in FIG. 6, FIG. 7, and FIG. 8, a single light source is used for a plurality of sensors (170, 670, 610, 710). It is then possible to eliminate or significantly reduce noise sources by a differential measurement between the sensors and to gain control of the internal drift of the optical system. In other words, with the drift being identical on the multi-sensor array, it can be eliminated. Furthermore, the cost of the deployed sensors is limited by using a single light source.

It also will be understood that a single laser source can be used for said first measurement instrument and for at least one second measurement instrument (not shown in the figures), also allowing differential measurements to be carried out between the two instruments and allowing any form of internal drift or noise occurring for the two instruments to be eliminated.

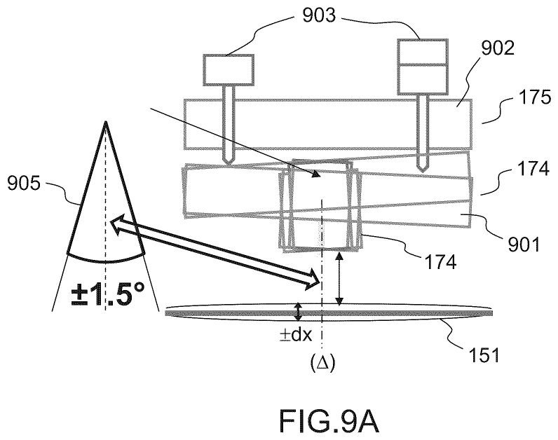

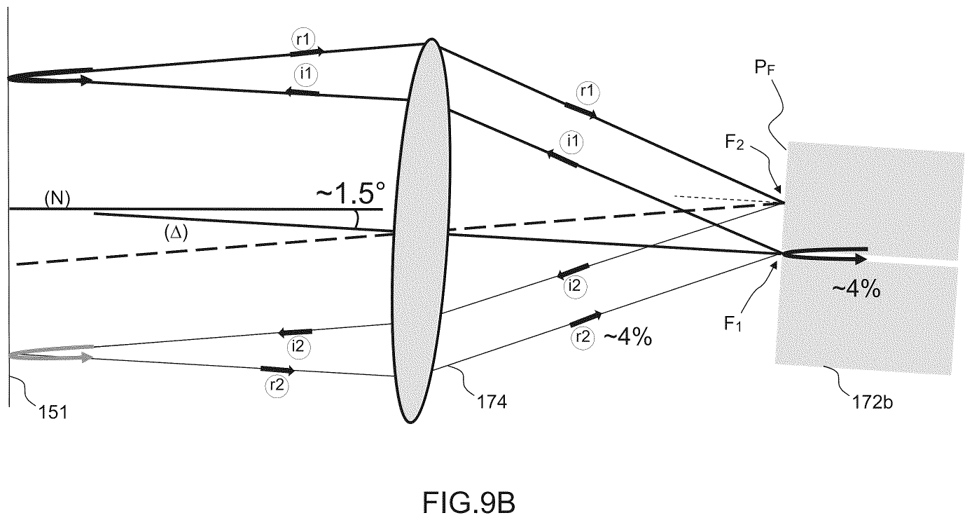

FIG. 9A shows a diagram of a collimator 174 in an example of a first fiber optic displacement sensor according to the present description. The collimator has an optical axis (Δ) and is configured for spatially shaping a light beam originating from the optical fiber 172b of the first sensor (FIG. 1), in order to produce the collimated light beam B₁ and to direct it toward the membrane 150, which is located, for example, between approximately 5 mm and approximately 20 mm from an exit face of the collimator. More specifically, in some embodiments, the collimated light beam is incident in a substantially perpendicular manner on the reflective central portion 151 of the membrane.

As illustrated in FIG. 9A, the collimator is mounted on an alignment plate 175 that allows the optical axis of the collimator to be oriented in a cone with an apex angle, for example, ranging between approximately ±5°. The alignment plate comprises, for example, a movable support 901 where the collimator is arranged, a fixed support 902 and adjustment screws 903 configured to modify the incline of the movable support 901 relative to the fixed support 902 about two axes contained in the plane of the movable support. This results in pivoting of the optical axis of the collimator in a cone 905 substantially centered on a direction perpendicular to the plane of the fixed support.

The applicants have shown that the first fiber optic displacement sensor thus described is extremely robust in that it operates perfectly well even with a slight alignment fault of the collimator of ±1.5°, which results in a slight alignment fault of the optical axis of the collimator with a direction perpendicular to the membrane 151.

FIG. 9B thus shows a diagram illustrating the operation of the collimator shown in FIG. 9A in greater detail, when the collimator 174 has an alignment fault. In this embodiment, an object focal point of the collimator 174 is substantially located in an exit plane P_{F} of the optical fiber 172b.

By way of a reminder, in an optical displacement sensor comprising a Fabry-Pérot type interferometer, variations in an interference signal resulting from interference are measured between, on the one hand, a detection light beam (B₂, FIG. 2), which results from the reflection of the collimated incident light beam B₁ onto the membrane and, on the other hand, a reference light beam, which results from the reflection of the incident light at the end of the optical fiber 172b, with the reflection resulting from the glass/air interface. The detection beam enters the fiber 172b and combines with the reference beam to produce interference. Any movement or displacement of the reflective surface 151, or equivalently, any variation in the length of the optical cavity as induced by a variation in the position of the membrane will be expressed in the generation of dynamic interference fringes. This interference signal is then transmitted by the fiber circuit to the detection means 178 of the sensor (see FIG. 1), remote from the environment in which the measurement is carried out, and then processed in a known manner by the signal processing unit 179 in order to determine the displacement of the membrane and deduce a differential pressure measurement therefrom. As explained above, measurement artifacts related, for example, to variations in the wavelength of the emission source, variations in temperature, internal drift, etc., can be corrected.

As illustrated in FIG. 9B, a portion of the incident beam is reflected at the tip of the fiber in order to return to the latter with a light intensity that is close to 4% (reference beam). Another portion of the beam originates from the end of the core of the optical fiber 172b placed at the optical focal point F₁ (“primary” optical focal point) of the collimator 174 so as to form an incident beam i₁. The incident beam in is collimated by the lens of the collimator 174 and is reflected by the membrane into a beam r₁ that is no longer parallel to the beam i₁ due to the initial misalignment; the beam r₁ is again transmitted by the lens, which converges it toward a point F₂ of the focal plane offset from the primary focal point (“secondary” focal point). The beam r₁ is reflected onto the plane of the end of the fiber (ferrule) into a beam i₂ passing through the lens in order to be collimated again and thus be located parallel to the preceding beam r₁ between the lens and the target. The beam i₂ is reflected, like the beam i₁, onto the target into a beam r₂ that is parallel to the first incident beam i₁ between the lens and the target. The beam r₂ is then perfectly oriented in the direction allowing it to return, after passing through the lens, to the first primary focal point located at the core of the fiber. It therefore automatically penetrates the fiber after two reflections in order to interfere with the reference beam.

This double reflection, as well as the reflection on the secondary focal point located on the plane of the tip of the fiber with a low reflection coefficient, allows a beam to be provided with less light intensity, around 4% of the initial beam, which allows the interference with the reference beam to be optimized, which itself returns to the fiber at a height of 4%. With a double reflection, the optical path is two times greater, which increases the sensitivity of the measurement by a factor of 2.

Thus, as explained above, the use of a collimator arranged in such a way that the optical focal point is located in the plane of the end of the tip of the fiber 172b allows all the optical beams exiting the tip of the fiber 172b to be collimated and thus allows the membrane to be focused at a greater centimetric distance than in the prior art. This significant distance is also possible by virtue of the use of the alignment plate 175 and of the double reflection between the membrane and the tip of the fiber located at the focal point of the collimator. This process of double reflection allows significant deviation in misalignment close to ±1.5°, thereby allowing operation without any risk of the optical beam returning into the fiber.

The collimated beam can thus focus the membrane through a liquid constantly connected to the external pressure. This provides the possibility of having liquid on either side of the membrane in order to obtain an equal pressure. It is then possible to select a membrane with more sensitive mechanical properties (large diameter and low thickness) in order to reach resolutions close to 1 Pa~0.1 mm of water, while maintaining a larger displacement range and therefore a considerably greater measurement range up to 5 bars~50 m.

The instrument can be displaced, transported at equal pressure, in an environment transitioning from low to high pressures, for example, when descending to a seabed up to 600 bar or more without any risk of damage to the elements forming the instrument, notably the membrane, which is not the case in the prior art.

Although it has been described through a certain number of embodiments, the systems for measuring differential pressure according to the present description include various variants, modifications and improvements that will appear obvious to a person skilled in the art, with it being understood that these various variants, modifications and improvements are part of the scope of the invention as defined by the following claims.

### REFERENCES

[Reference 1]: POLSTER, André, FABIAN, Marcus, VILLINGER, Heinrich, “Effective resolution and drift of Paroscientific pressure sensors derived from long-term seabed measurement”; Geochemistry, geophysics, geosystems, Vol. 10, Number 8 (2009).
[Reference 2]: TIAN, Bian, ZHAN, Feng, HAN, Feng, et al., “An optical fiber Fabry-Pérot micro-pressure sensor based on beam-membrane structure”; Measurement Science and Technology, 2018, vol. 29, no. 12, p. 125104.
[Reference 3]: FR 2963421

1. A system for measuring differential pressure in an underwater environment, comprising:
at least one first transceiver unit comprising a light source, detection means and signal processing means;
at least one first fiber measurement instrument configured to be positioned in a first position in said underwater environment and comprising:
a first rigid compartment in sealed fluid connection with a first rigid tube, the first compartment being filled with a first liquid;
a second at least partially rigid compartment in sealed fluid connection with a second at least partially flexible tube, the second compartment being filled with a second liquid;
a third tube for underwater pressure tapping, said third tube opening into the underwater environment and being in fluid connection with the second tube;
at least one first valve configured to allow, in the open position, a fluid connection between the first tube and the second tube, in order to maintain the first compartment and the second compartment at equal pressure, and configured to sealably separate, in the closed position, the first tube from the second tube;
a membrane configured to separate the first compartment and the second compartment;
a third sealed compartment filled with a fluid at atmospheric pressure;
at least one first window, transparent within a given wavelength range, arranged in a shared wall between said third compartment and one of the first or second compartments;
at least one first fiber optic head configured to form a first fiber interferometric sensor with said first transceiver unit, wherein said first fiber interferometric sensor is configured to measure, in the closed position of the first valve, through said first window, at least a first displacement of the membrane resulting from a pressure variation between the first compartment and the second compartment when the first measurement instrument experiences a variation in underwater pressure.

2. The system for measuring differential pressure in an underwater environment as claimed in claim 1, wherein the first liquid and the second liquid are identical, with the first compartment and the second compartment being filled with the same liquid.

3. The system for measuring differential pressure in an underwater environment as claimed in claim 1, wherein the first liquid and the second liquid are different, immiscible.

4. The system for measuring differential pressure in an underwater environment as claimed in claim 1, wherein the at least one first fiber optic bead comprises:
a first optical fiber for conveying a light beam emitted by the light source toward the membrane, with an end of said first optical fiber being arranged in the third compartment;
a first collimator for collimating said light beam emitted by the source and originating from said first optical fiber, wherein said end of the first optical fiber is in an object focal plane of the collimator.

5. The system for measuring differential pressure in an underwater environment as claimed in claim 1, wherein said first measurement instrument further comprises:
a second fiber optic head arranged in said third compartment and configured to form, with said transceiver unit, a second fiber interferometric sensor configured to measure a temperature variation in said third compartment.

6. The system for measuring differential pressure in an underwater environment as claimed in claim 1, wherein said first measurement instrument further comprises:
a fourth sealed compartment filled with a fluid at atmospheric pressure;
a second window arranged in a shared wall between said fourth compartment and the other one from among the first or second compartments; and
a third fiber optic head configured to form a third fiber interferometric sensor with said first transceiver unit, wherein said third fiber interferometric sensor is configured to measure, in the closed position of the first valve, through said second window, a second displacement of the membrane resulting from a pressure variation between the first compartment and the second compartment when the system experiences a variation in underwater pressure.

7. The system for measuring differential pressure in an underwater environment as claimed in claim 1, wherein said first measurement instrument further comprises:
a fourth fiber optic head arranged in said third compartment and configured to form, with said first transceiver unit, a fourth fiber interferometric sensor configured to measure a drift in said first fiber optic displacement sensor.

8. The system for measuring differential pressure in an underwater environment as claimed in claim 1, wherein said first measurement instrument further comprises:
a fourth compartment in fluid communication with the first compartment, said fourth compartment comprising a wall and at least one first rigid element immersed in the first liquid flowing inside said fourth compartment, with said at least one first rigid element having a coefficient of thermal expansion lower than the coefficient of thermal expansion of the wall.

9. The system for measuring differential pressure in an underwater environment as claimed in claim 1, wherein said first measurement instrument further comprises a mechanical protection enclosure not sealed from the underwater environment, with the first compartment, the second compartment and the third compartment being arranged inside said enclosure.

10. The system for measuring differential pressure in an underwater environment as claimed in claim 1, further comprising a second differential pressure measurement instrument configured to be positioned in a second position in said underwater environment.

11. The system for measuring differential pressure in an underwater environment as claimed in claim 10, wherein said second measurement instrument is a fiber measurement instrument that cooperates with said first transceiver unit for measuring the differential pressure.

12. A method for measuring differential pressure in an underwater environment implemented by means of a system for measuring differential pressure as claimed in claim 1, comprising:
opening the first valve for establishing an equal pressure between the first compartment and the second compartment;
installing said first measurement instrument in the underwater environment where a differential pressure is intended to be measured;
closing the first valve so as to sealably separate the first tube from the second tube;
measuring, in the closed position of the first valve, through said window, a displacement of the membrane resulting from a pressure variation between the first compartment and the second compartment when the first measurement instrument experiences a variation in underwater pressure.
